(19) United States
(12) Patent Application Publication
(10) Pub. No.: US 2003/0228860 A1
(43) Pub. Date: Dec. 11, 2003

(54) Integrated radio-frequency receiver

(76) Inventor: Chewnpu Jou, Hsinchu Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,063

(22) Filed: Jun. 6, 2002

(51) Int. Cl. H04B 1/69; H04B 1/26

(52) U.S. Cl. 455/324; 375/147

(57) ABSTRACT

An integrated radio frequency receiver, having a local oscillator, a mixer apparatus, a phase-shift apparatus, and an analog-to-digital conversion apparatus. The local oscillator is used to generate a local oscillation signal. The mixer mixes, filters and amplifies a radio-frequency carrier input signal and the local oscillation signal to output the first amplified and second amplified signals. The phases of the first and second amplified signals are shifted with first and second degrees as first and second output phase-shifted signals, respectively. The analog-to-digital conversion apparatus then performs analog-to-digital conversion on the first amplified and the second phase-shifted signal, and the second amplified and first phase-shifted signal to output an in-phase signal and an orthogonal-phase signal, respectively.

### BACKGROUND OF INVENTION

1. Field of the Invention

The invention relates in general to a radio-frequency receiver, and more particularly, to an integrated radio-frequency receiver using a phase-shift apparatus to reduce the intermediate frequency.

2. Related Art of the Invention

A prior art zero-intermediate-frequency (ZIF) radio-frequency (RF) receiver is shown as FIG. 1. The zero-intermediate-frequency RF receiver 10 includes a local oscillator (LO) 102, a pair of mixers 104 and 106, a pair of low-pass filters 108 and 110, a phase-shift network 122, and a base-band demodulator 12. The base-band demodulator 12 further comprises a pair of delays 112 and 114, a pair of arithmetic operators 116 and 118, and an adder 120. The frequency of the local oscillator 102 is equivalent to that of a radio-frequency-carrier input signal A(t). The zero-intermediate-frequency RF receiver 10 is used to directly demodulate the frequency modulation (FM) or phase modulation (PM) signal. The prior art zero-intermediate-frequency radio-frequency receiver 10 typically suffers from the following problems.

(1) The DC offset or flicker noise of the base-band demodulator 12 affects the sensitivity of the zero-intermediate-frequency radio-frequency receiver 10.

(2) The leakage current of the local oscillator 102 reduces the DC signal level for conversion, such that another DC offset is generated.

To improve the above problems, another conventional method sets the frequency of the local oscillator as that of two channels at central frequency of the leaving radio-frequency-carrier input signal, and changes the zero-intermediate-frequency RF receiver into a RF receiver with a low intermediate frequency. Though the above problems are improved, the following problems occur.

(1) The image rejection problem non-existent in the original zero-intermediate-frequency RF receiver now becomes serious. Assuming that the local oscillator has a frequency f_{LO} and the intermediate frequency is f_{IF}, for the required signal at the frequency f_{LO}+f_{IF} falling into the signal band and the unwanted signal at frequency f_{LO}−f_{IF} falling beyond the signal band, an image rejection problem occurs. The conventional method to resolve the image rejection problem includes the addition of an image rejection mixer or a poly-phase filter. However, the capacitor and resistor for low frequency have a large volume, such that the image rejection mixer and the poly-phase filter will occupy a large area of the silicon chip. It is even worse that the fabrication process of such analog circuit is very sensitive, so that the yield of the integrated circuit is consequently decreased.

(2) As the wireless system with a channel bandwidth of 802.11B has a wider channel of which the frequency is 22 MHz, the intermediate frequency of two channels leaving the zero mean highest signal frequency is at least 44 MHz. For most of the demodulators of modem digital signal process type (DSP), the sampling signals are transmitted to the analog-to-digital converter (ADC) with four to eight times of sampling rate. Therefore, the DSP circuit operates at mega samples per second (MSPS). The design and fabrication are thus very difficult, and massive power and large silicon chip area are consumed.

### SUMMARY OF INVENTION

The present invention provides an integrated radio-frequency receiver. A phase-shift apparatus is used to decrease the frequency deviation between the local oscillator and the radio-frequency carrier input signal; and consequently, the sampling rate is reduced. Further, the DC offset, the leakage current of the local oscillator and the image rejection problem is resolved.

The integrated radio-frequency receiver comprises a local oscillator, a mixer, a phase-shift apparatus and an analog-to-digital conversion apparatus. The local oscillator is used to generate a local oscillation signal. The mixer apparatus is coupled to the local oscillator to receive and mix, filter, and amplify a radio-frequency carrier input signal and the local oscillation signal to output a first and a second amplified signals. The phase-shift apparatus is coupled to the mixer apparatus for shifting the phases of the first and second amplified signals with a first degree and a second degree, respectively, so as to output a first phase-shifted signal and a second phase-shifted signal. The analog-to-digital conversion apparatus is coupled to the mixer apparatus and the phase-shift apparatus to receive the first and second amplified signals and the first and second phase-shifted signals, respectively. Analog-to-digital conversion are then performed on the first amplified signal and the second phase-shift signal, and the second amplified signal and the first phase-shift signal, so that an in-phase signal and an orthogonal-phase signal are output.

The present invention further provides an integrated radio-frequency receiver having a local oscillator, a 90° phase shifter, a first mixer, a second mixer, a first filter, a second filter, a first amplifier, a second amplifier, a first phase shifter, a second phase shifter, a first sample-maintaining apparatus, a second sample-maintaining apparatus, and a second analog-to-digital converter. The local oscillator is used to generate a local oscillation signal. The 90° phase shifter is coupled to the local oscillator to receive the local oscillation signal, and to perform a 90° phase shift thereon and output the 90°-shifted local oscillation signal. The first mixer is coupled to the local oscillator to receive and mix a radio-frequency carrier input signal and the 90°-shifted local oscillation signal, so as to output a first intermediate-frequency signal. The second mixer is coupled to the local oscillator to receive and mix the radio-frequency carrier input signal and the 90°-shifted local oscillation signal, so as to output a second intermediate-frequency signal. The first filter is coupled to the first mixer to receive and filter the first intermediate-frequency signal, so as to output a first base-band signal. The second filter is coupled to the first mixer to receive and filter the second intermediate-frequency signal, so as to output a second base-band signal. The first amplifier coupled to the first filter receives and amplifies the first base-band signal, and outputs a first amplified signal. The second amplifier coupled to the second filter receives and amplifies the second base-band signal, and outputs a second amplified signal. The first phase shifter coupled to the first amplifier receives and shifts the phase of the first amplified signal with a first degree to output a first phase-shifted signal. The second phase shifter coupled to the second amplifier receives and shifts the phase of the second amplified signal with a second degree to output a second phase-shifted signal. The first sample-maintaining apparatus is coupled to the first amplifier and the second phase shifter to receive and perform arithmetic operation and sample maintaining on the first amplified signal and the second phase-shifted signal, so as to output a first sample-maintaining signal. The second sample-maintaining apparatus is coupled to the second amplifier and the first phase shifter to receive and perform arithmetic operation and sample maintaining on the second amplified signal and the first phase-shifted signal, so as to output a second sample-maintaining signal. The first analog-to-digital converter is coupled to the first sample-maintaining apparatus to receive and perform analog-to-digital conversion on the first sample-maintaining signal, so as to output an in-phase signal. The second analog-to-digital converter is coupled to the second sample-maintaining apparatus to receive and perform analog-to-digital conversion on the second sample-maintaining signal, so as to output an orthogonal-phase signal.

In one embodiment of the present invention, the first and second degrees are 90°, the first and second phase shifters reduce the intermediate frequency and can be implemented by a switching capacitor circuit.

In one embodiment of the present invention, the first filter and second filter include low-pass filters.

Further, in one embodiment of the present invention, the integrated radio-frequency receiver includes a single side band receiver.

Accordingly, the present invention uses a phase shifter to decrease frequency deviation between the local oscillation signal and the radio-frequency carrier input signal, so that the sampling rate is reduced without occurrence of DC offset, current leakage of local oscillator or image rejection. In addition, the phase shifter can be implemented by switching capacitor circuit, such that a simple and high-yield circuit can be implemented.

### BRIEF DESCRIPTION OF DRAWINGS

These, as well as other features of the present invention, will become more apparent upon reference to the drawings wherein:

FIG. 1 shows a block diagram of a prior art radio-frequency receiver;

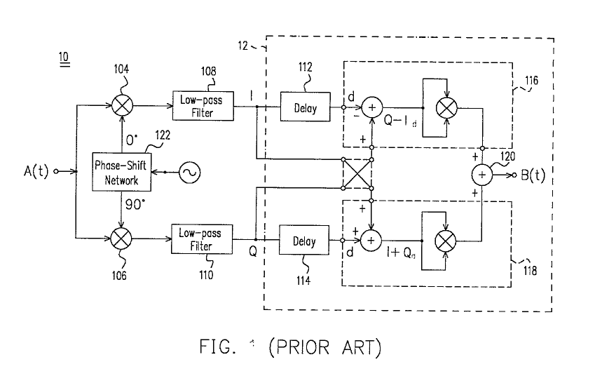

FIG. 2 is a block diagram of an integrated radio-frequency receiver in one embodiment of the present invention; and

FIG. 3 shows the signal spectrum of an integrated radio-frequency receiver in one embodiment of the present invention.

### DETAILED DESCRIPTION

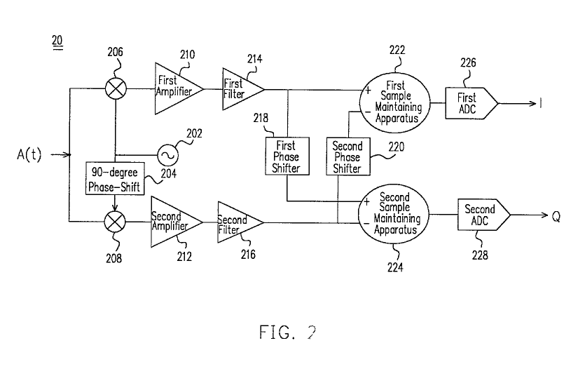

Referring to FIG. 2, a block diagram of an integrated radio-frequency receiver in one embodiment of the present invention is shown. The integrated radio-frequency receiver 20 includes a local oscillator 202, a 90° phase shifter 204, first and second mixers 206 and 208, first and second filters 210 and 212, first and second amplifiers 214 and 216, first and second phase shifters 218 and 220, first and second sample-maintaining apparatus 222 and 224, and first and second analog-to-digital converters 226 and 228. The functions for each part of the integrated radio-frequency receiver 20 are introduced as follows.

The local oscillator 202 generates a local oscillation signal. The 90° phase shifter 204 shifts the phase of the local oscillation signal by 90° and inputs the 90° phase-shifted local oscillation signal, that is, an orthogonal-phase local oscillation signal. The first mixer 206 mixes a frequency-radio carrier input signal A(t) with the local oscillation signal, such that the frequency down conversion is performed on the radio-frequency carrier input signal A(t), and a first intermediate-frequency signal is output. The second mixer 208 mixes the radio-frequency input signal A(t) and the orthogonal-phase local oscillation signal, such that frequency down conversion is performed on the radio-frequency input signal, and a second intermediate-frequency signal is output. The first filter 210 filters the first intermediate-frequency signal to output a first base-band signal by decaying the unwanted harmonic signal of the first intermediate-frequency signal. The second filter 212 filters the second intermediate-frequency signal to output a second base-band signal by decaying the unwanted harmonic signal of the second intermediate-frequency signal. Preferably, the first and second filters 210 and 212 include low-pass filters. The first amplifier 214 amplifies the first base-band signal to output a first amplified signal, while the second amplifier 216 amplifies the second base-band signal to output a second amplified signal. The first and second phase shifters 218 and 220 shift the phases of the first and second amplified signals with a first degree and a second degree, so as to output first and second phase-shifted signals, respectively. Thereby, the intermediate frequency is reduced. The first sample maintaining apparatus 222 performs arithmetic operation and sample maintaining on the first amplified signal and the second phase-shifted signal, such that a first sample-maintaining signal is output. The second sample maintaining apparatus 224 performs arithmetic operation and sample maintaining on the second amplified signal and the first phase-shifted signal, such that a second sample-maintaining signal is output. The first analog-to-digital converter 226 performs analog-to-digital conversion on the first sample-maintaining signal to output an in-phase signal 1, while the second analog-to-digital converter 228 performs analog-to-digital conversion on the second sample-maintaining signal to output an orthogonal-phase signal Q. The in-phase and orthogonal-phase signals are both upper side band signals.

The integrated radio-frequency receiver 20 uses the first and second phase shifters 218 and 220 to reduce the intermediate frequency, so that the image rejection is avoided. The way to avoid occurrence of image rejection is described as follows. Assuming that the frequency of the local oscillation signal generated by the local oscillator 202 is f_{LO}, and the intermediate frequency is f_{IF}, to have the required signal at the frequency f_{LO}+f_{IF} falling within the signal band, and the unwanted signal at the frequency f_{LO}−f_{IF} falling beyond the signal band, the first and second phase shifters 218 and 220 are used in the present invention to reduce the intermediate frequency f_{IF}. Therefore, the unwanted signal at the frequency f_{LO}−f_{IF} and the required signal at the frequency f_{LO}+f_{IF} both fall within the signal band to eliminate the image rejection. In addition, the single side band (SSB) integrated radio-frequency receiver 20 can be assembled by the arithmetic operation such as addition or subtraction of the first and second sample maintaining apparatus 222 and 224.

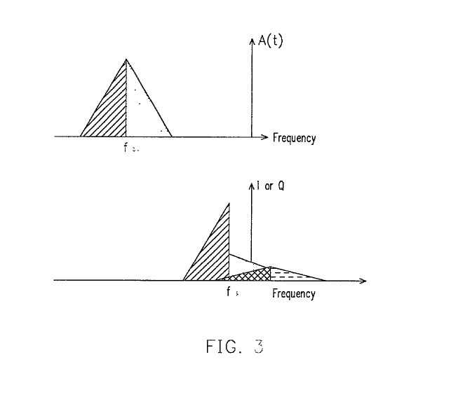

In addition, the frequency deviation between the local oscillation signal and the radio-frequency carrier input signal is reduced to a few MHz, where the relative spectrum is shown in FIG. 3. The demodulation operation is performed in accordance with the in-phase signal I and the orthogonal-phase signal Q. The frequency of the maximum signal at 802.11B is only about 25 MHz, so that the sampling rate is about 100 MSPS only. Therefore, the design and fabrication are easy, and the excessive power source and area of silicon chip are saved.

The actual circuits of the first and second phase shifters 218 and 220 can be implemented by switching capacitor circuits (in the Hilbert region), so that a simple circuit with a high yield can be obtained.

According to the above, the present invention has at least the following advantages.

1. The frequency deviation between the local oscillation signal and the radio-frequency carrier input signal is reduced by the first and the second phase shifters, so that the sampling rate is decreased.

2. Problems of DC offset and current leakage of the local oscillation are resolved.

3. The image rejection is eliminated by using the first and second phase shifters.

4. The first and second phase shifters can be implemented by switching capacitor circuit, so that a simple circuit with a high yield can be obtained.

Other embodiments of the invention will appear to those skilled in the art from consideration of the specification and practice of the invention disclosed herein. It is intended that the specification and examples are to be considered as exemplary only, with a true scope and spirit of the invention being indicated by the following claims.

1. An integrated radio-frequency receiver, comprising:
a local oscillator, to generate a local oscillation signal;
a mixer apparatus, coupled to the local oscillator to receive a radio-frequency carrier input signal and the local oscillation signal, and to mix, filter and amplify the radio-frequency carrier input signal and the local oscillation signal to output a first amplified signal and a second amplified signal;
a phase-shift apparatus, coupled to the mixer apparatus to shift phases of the first and second amplified signals with a first degree and a second degree, and to output a first phase-shifted signal and a second phase-shifted signal; and
an analog-to-digital conversion apparatus, coupled to the mixer apparatus and the phase-shift apparatus to receive the first amplified signal and the second phase-shifted signal, and the second amplified signal and the first phase-shifted signal, so as to output an in-phase signal and an orthogonal-phase signal by performing analog-to-digital conversion thereon, respectively.

2. The integrated radio-frequency receiver according to claim 1, wherein the phase-shift apparatus comprises:
a first phase shifter, coupled to the mixer apparatus and the analog-to-digital conversion apparatus to receive the first amplified signal, and to shift the first amplified signal with the first degree to output the first phase-shifted signal; and
a second phase shifter, coupled to the mixer apparatus and the analog-to-digital conversion apparatus to receive the second amplified signal, and to shift the second amplified signal with the second degree to output the second phase-shifted signal.

3. The integrated radio-frequency receiver according to claim 2, wherein the first degree is 90°.

4. The integrated radio-frequency receiver according to claim 2, wherein the second degree is 90°.

5. The integrated radio-frequency receiver according to claim 2, wherein the first phase shifter is operative to reduce an intermediate frequency.

6. The integrated radio-frequency receiver according to claim 2, wherein the second phase shifter is operative to reduce an intermediate frequency.

7. The integrated radio-frequency receiver according to claim 2, wherein the first phase shifter is implemented by a switching capacitor circuit.

8. The integrated radio-frequency receiver according to claim 2, wherein the second phase shifter is implemented by a switching capacitor circuit.

9. The integrated radio-frequency receiver according to claim 1, wherein the mixer apparatus comprises:
a 90° phase shifter, coupled to the local oscillator to receive the local oscillation signal and to shift the local oscillation signal by 90°, and to output a 90° shifted local oscillation signal;
a first mixer, coupled to the local oscillator to receive and mix the radio-frequency carrier input signal and the local oscillation signal, so as to output a first intermediate-frequency signal;
a second mixer, coupled to the 90° phase shifter to receive and mix the local radio-frequency carrier input signal and the 90° shifted local oscillation signal, so as to output a second intermediate-frequency signal;
a first filter, coupled to the first mixer to receive the first intermediate-frequency signal and to filter the first intermediate-frequency signal to output a first base-band signal;
a second filter, coupled to the second mixer to receive the second intermediate-frequency signal and to filter the second intermediate-frequency signal to output a second base-band signal;
a first amplifier, coupled to the first filter to receive and amplify the first base-band signal and output a first amplified signal; and
a second amplifier, coupled to the second filter to receive and amplify the second base-band signal and output a second amplified signal.

10. The integrated radio-frequency receiver according to claim 9, wherein the first filter includes a low-pass filter.

11. The integrated radio-frequency receiver according to claim 9, wherein the second filter includes a low-pass filter.

12. The integrated radio-frequency receiver according to claim 1, wherein the analog-to-digital conversion apparatus comprises:
a first sample maintaining apparatus, coupled to the mixer apparatus and the phase-shift apparatus to receive the first amplified signal and the second phase-shifted signal, and to perform arithmetic operation and sample maintaining thereon to output a first sample maintaining signal;
a second sample maintaining apparatus, coupled to the mixer apparatus and the phase-shift apparatus to receive the second amplified signal and the first phase-shifted signal, and to perform arithmetic operation and sample maintaining thereon to output a second sample maintaining signal;
a first analog-to-digital converter, coupled to the first sample maintaining apparatus to receive the first sample maintaining signal, and to perform analog-to-digital conversion thereon to output the in-phase signal; and
a second analog-to-digital converter, coupled to the second sample maintaining apparatus to receive the second sample maintaining signal, and to perform analog-to-digital conversion thereon to output the orthogonal-phase signal.

13. The integrated radio-frequency receiver according to claim 1, including a single-side-band receiver.

14. An integrated radio-frequency receiver, comprising:
a local oscillator, to generate a local oscillation signal;
a 90° phase shifter, coupled to the local oscillator to receive the local oscillation signal and to shift the phase of the local oscillation signal by 90° into a 90° shifted local oscillation signal to be output;
a first mixer, coupled to the local oscillator to receive and mix a radio-frequency carrier input signal and the local oscillation signal to output a first intermediate-frequency signal;
a second mixer, coupled to the 90° phase shifter to receive and mix the radio-frequency carrier input signal and the 90° shifted local oscillation signal to output a second intermediate-frequency signal;
a first filter, coupled to the first mixer to receive and filter the first intermediate-frequency signal to output a first base-band signal;
a second filter, coupled to the second mixer to receive and filter the second intermediate-frequency signal to output a second base-band signal;
a first amplifier, coupled to the first filter to receive and amplify the first base-band signal and output a first amplified signal;
a second amplifier, coupled to the second filter to receive and amplify the second base-band signal and output a second amplified signal;
a first phase shifter, coupled to the first amplifier to receive and shift the phase of the first amplified signal with a first degree, so as to output a first phase-shifted signal;
a second phase shifter, coupled to the second amplifier to receive and shift the phase of the second amplified signal with a second degree, so as to output a second phase-shifted signal;
a first sample maintaining apparatus, coupled to the first amplifier apparatus and the second phase shifter to receive the first amplified signal and the second phase-shifted signal, and to perform arithmetic operation and sample maintaining thereon to output a first sample maintaining signal;
a second sample maintaining apparatus, coupled to the second amplifier and the first phase shifter to receive the second amplified signal and the first phase-shifted signal, and to perform arithmetic operation and sample maintaining thereon to output a second sample maintaining signal;
a first analog-to-digital converter, coupled to the first sample maintaining apparatus to receive the first sample maintaining signal, and to perform analog-to-digital conversion thereon to output the in-phase signal; and
a second analog-to-digital converter, coupled to the second sample maintaining apparatus to receive the second sample maintaining signal, and to perform analog-to-digital conversion thereon to output the orthogonal-phase signal.

15. The integrated radio-frequency receiver according to claim 14, wherein the first degree is 90°.

16. The integrated radio-frequency receiver according to claim 14, wherein the second degree is 90°.

17. The integrated radio-frequency receiver according to claim 14, wherein the first phase shifter is operative to reduce the frequency of an intermediate frequency.

18. The integrated radio-frequency receiver according to claim 14, wherein the second phase shifter is operative to reduce the frequency of an intermediate frequency.

19. The integrated radio-frequency receiver according to claim 14, wherein the first phase shifter is implemented by a switching capacitor circuit.

20. The integrated radio-frequency receiver according to claim 14, wherein the second phase shifter is implemented by a switching capacitor circuit.

21. The integrated radio-frequency receiver according to claim 14, wherein the first filter includes a low-pass filter.

22. The integrated radio-frequency receiver according to claim 14, wherein the second filter includes a low-pass filter.

23. The integrated radio-frequency receiver according to claim 14, including a single-side-band receiver.
